(19) United States
(12) Patent Application Publication
(10) Pub. No.: US 2021/0291856 A1
(43) Pub. Date: Sep. 23, 2021

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Naoki UENOYAMA, Nagoya-shi (JP); Josuke YAMANE, Nisshin-shi (JP); Rio MINAGAWA, Nagoya-shi (JP)

(73) Assignee: TOYOTA JIDOSHA KABUSHIKI KAISHA, Toyota-shi (JP)

(21) Appl. No.: 17/199,707

(22) Filed: Mar. 12, 2021

(30) Foreign Application Priority Data
Mar. 17, 2020 (JP) 2020- 046288

(51) Int. Cl. B60W 60/00; B60W 40/107; B60W 40/04

(52) U.S. Cl. CPC B60W 60/001; B60W 40/107; B60W 2554/80; B60W 2556/65; B60W 2556/10; B60W 40/04

(57) ABSTRACT

A controller is provided which is configured to execute: obtaining a situation around a vehicle or a road situation to generate reference data, which is data of a driving operation serving as a reference; and performing predetermined processing when a degree of deviation between driving data, which is data of a driving operation by a driver of the vehicle, and the reference data is equal to or greater than a threshold value.

### CROSS REFERENCE TO THE RELATED APPLICATION

This application claims the benefit of Japanese Patent Application No. 2020-046288, filed on Mar. 17, 2020, which is hereby incorporated by reference herein in its entirety.

### BACKGROUND

### Technical Field

The present disclosure relates to an information processing apparatus, an information processing method, and a non-transitory storage medium.

### Description of the Related Art

There has been known a technique in which in a vehicle capable of switching between a manual driving state and an automatic driving state, the driving skill of a driver is evaluated by comparing a result of a driving operation of the driver with an automatic control content calculated based on a surrounding situation of the vehicle (for example, see Patent Literature 1).

### CITATION LIST

### Patent Literature

Patent Literature 1: Japanese Patent Application Laid-Open Publication No. 2018-176913

### SUMMARY

An object of the present disclosure is to prevent a driver from performing an inappropriate driving operation during manual driving.

One aspect of the present disclosure is directed to an information processing apparatus including a controller configured to execute:

obtaining a situation around a vehicle or a road situation, and generating reference data, which is data of a driving operation serving as a reference; and

performing predetermined processing when a degree of deviation between driving data, which is data of a driving operation by a driver of the vehicle, and the reference data is equal to or greater than a threshold value.

Another aspect of the present disclosure is directed to an information processing method for causing a computer to execute:

obtaining a situation around a vehicle or a road situation, and generating reference data, which is data of a driving operation serving as a reference; and
performing predetermined processing when a degree of deviation between driving data, which is data of a driving operation by a driver of the vehicle, and the reference data is equal to or greater than a threshold value.

A further aspect of the present disclosure is directed to a non-transitory storage medium with a program stored therein, the program being configured to cause a computer to execute:

obtaining a situation around a vehicle or a road situation, and generating reference data, which is data of a driving operation serving as a reference; and
performing predetermined processing when a degree of deviation between driving data, which is data of a driving operation by a driver of the vehicle, and the reference data is equal to or greater than a threshold value.

In addition, a still further aspect of the present disclosure is directed to the above-mentioned program.

According to the present disclosure, it is possible to prevent a driver during manual driving from performing an inappropriate driving operation.

### BRIEF DESCRIPTION OF THE DRAWINGS

FIG. 1 is a block diagram schematically illustrating an example of a configuration of a vehicle according to an embodiment;

FIG. 2 is a diagram illustrating an example of a functional configuration of a controller of the vehicle according to a first embodiment;

FIG. 3 is a flowchart of the processing of evaluating a driving operation of a driver according to the first embodiment;

FIG. 4 is a flowchart of processing in the case where notification processing is performed only when a state in which an absolute value of a value obtained by subtracting reference data from detection data is equal to or greater than a threshold value continues for a predetermined length of time or more;

FIG. 5 is a view illustrating a schematic configuration of a system according to a second embodiment;

FIG. 6 is a block diagram schematically illustrating an example of a configuration of a server constituting the system according to the second embodiment;

FIG. 7 is a diagram illustrating an example of a functional configuration of a controller of a vehicle according to the second embodiment;

FIG. 8 is a diagram illustrating an example of a functional configuration of the server;

FIG. 9 is a diagram illustrating an example of a table configuration stored in a vehicle information DB;

FIG. 10 is a sequence diagram of the processing of the system at the time when the server provides other vehicle data to a first vehicle;

FIG. 11 is a flowchart illustrating an example of the processing of the server at the time when the server updates the vehicle information DB;

FIG. 12 is a flowchart illustrating an example of the processing of the server at the time when the server transmits the other vehicle data to the first vehicle;

FIG. 13 is a flowchart illustrating a flow of the processing of transmitting detection data and the like to the server in each vehicle;

FIG. 14 is a flowchart of processing in the case of performing notification processing according to the second embodiment; and

FIG. 15 is a flowchart of processing at the time of correcting a threshold value based on a degree of reliability of a sensor group.

### DESCRIPTION OF THE EMBODIMENTS

An information processing apparatus, which is one aspect of the present disclosure, obtains a situation around a vehicle or a road situation. The “situation” to be obtained may be any situation that affects a driving operation of the vehicle. The situation around the vehicle may be, for example, a situation obtained by a sensor. The situation around the vehicle may be, for example, a situation of obstacles around the vehicle, a situation of a road surface, a situation of other vehicles present around the own vehicle, a situation of traffic congestion, a situation of road construction, or the like. The road situation may be, for example, a situation obtained from a road map (e.g., a situation such as a curvature of a road or the like). Data (reference data) related to the driving operation, which serves as a reference, is generated according to these situations. For example, the reference data may be data representing an ideal driving operation according to the situation around the vehicle or the road situation. The driving operation is an operation associated with traveling of the vehicle, such as an accelerator operation, a steering wheel operation, or a brake operation.

The controller performs predetermined processing when a degree of deviation between data (driving data) related to the driving operation by the driver of the vehicle and the reference data is equal to or greater than a threshold value. The driving operation by the driver is data obtained when the driver operates the vehicle during manual driving. The degree of deviation between the driving data and the reference data can be expressed, for example, by a difference between or ratio of acceleration and deceleration values, or by a difference between or a ratio of amounts of change of steering angle per unit time (hereinafter, also referred to as rates of change of steering angle). It means that the larger the degree of deviation between the driving data and the reference data, the more the driving operation of the driver deviates from a driving operation which becomes a reference. In cases where the degree of deviation is equal to or greater than the threshold value, the controller performs the predetermined processing. The threshold value is, for example, a degree of deviation in the case where the driving operation by the driver is inappropriate. The predetermined processing may be processing to the driver, processing to the vehicle, or processing to the outside of the vehicle. The processing to the driver may be, for example, processing for warning or notifying the driver. The processing to the vehicle may be, for example, processing related to an accelerator operation, a brake operation, or a steering operation. The processing to the outside of the vehicle may be, for example, processing for warning or notifying other vehicles around the own vehicle, processing for notifying an external organization (e.g., the police), or processing for causing a server to store that an inappropriate driving operation has been performed. Since the predetermined processing is performed in cases where there is an inappropriate driving operation during manual driving by the driver, it is possible to urge the driver to refrain from the inappropriate driving operation.

Hereinafter, embodiments of the present disclosure will be described based on the accompanying drawings. The configurations of the following embodiments are some examples, and the present disclosure is not limited to the configurations of the embodiments. The following embodiments can be combined with one another as long as they do not conflict with one another.

### First Embodiment

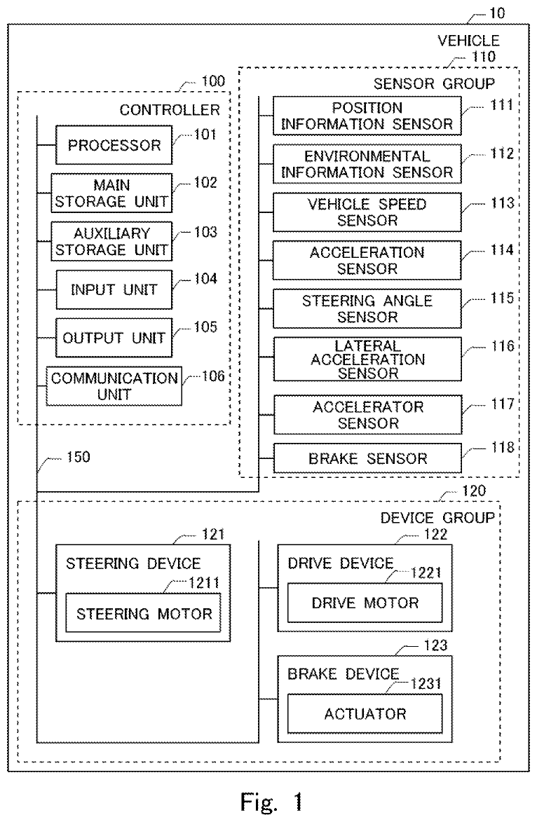

FIG. 1 is a block diagram schematically illustrating an example of a configuration of a vehicle 10 according to a first embodiment. The vehicle 10 is a vehicle capable of automatic driving and manual driving. The automatic driving is driving that is not based on the driving operation of the driver, whereas the manual driving is driving that is based on the driving operation of the driver. The vehicle 10 obtains information about the surroundings of the vehicle 10, information on roads around the vehicle 10, and information related to the driving operation of the driver, and evaluates the driving operation of the driver based on these pieces of information. The vehicle 10 includes a controller 100, a sensor group 110, and a device group 120. These components are connected to one another by a bus 150.

The controller 100 is a computer that controls the components of the vehicle 10. The controller 100 includes a processor 101, a main storage unit 102, an auxiliary storage unit 103, an input unit 104, an output unit 105, and a communication unit 106. The processor 101 is a central processing unit (CPU), a digital signal processor (DSP), or the like. The processor 101 performs the calculation of various types of information processing for controlling the vehicle 10.

The main storage unit 102 is a random access memory (RAM), a read only memory (ROM), or the like. The auxiliary storage unit 103 is an erasable programmable ROM (EPROM), a hard disk drive (HDD), a removable medium, or the like. The auxiliary storage unit 103 also stores an operating system (OS), various kinds of programs, various kinds of tables, and the like. The processor 101 loads a program stored in the auxiliary storage unit 103 into a work area of the main storage unit 102 and executes the program, so that each component or the like is controlled through the execution of the program. The main storage unit 102 and the auxiliary storage unit 103 are computer readable recording media. In the configuration illustrated in FIG. 1, a plurality of computers may cooperate with each other. In addition, the information stored in the auxiliary storage unit 103 may be stored in the main storage unit 102. Also, the information stored in the main storage unit 102 may be stored in the auxiliary storage unit 103.

The input unit 104 is a means or unit that serves to receive an input operation performed by the driver, and is, for example, a touch panel, a push button, a mouse, a keyboard, or the like. The output unit 105 is a means or unit that serves to present information to the driver, and is, for example, a liquid crystal display (LCD), an electroluminescence (EL) panel, a speaker, a lamp, or the like. The input unit 104 and the output unit 105 may be configured as a single touch panel display.

The communication unit 106 is a communication means or unit for connecting the vehicle 10 to an external network. The communication unit 106 is a circuit for communicating with other devices (e.g., an external server and the like) via a network by making use of a mobile communication network service (e.g., a telephone communication network such as 5G (5th Generation), 4G (4th Generation), 3G (3rd Generation), or LTE (Long Term Evolution)) or a wireless communication network such as Wi-Fi (registered trademark) or the like.

The sensor group 110 is various sensors that obtain information related to the traveling of the vehicle 10. The sensor group 110 includes, for example, a position information sensor 111, an environmental information sensor 112, a vehicle speed sensor 113, an acceleration sensor 114, a steering angle sensor 115, a lateral acceleration sensor 116, an accelerator sensor 117, and a brake sensor 118. The detection values obtained by the sensor group 110 are recorded, for example, in the auxiliary storage unit 103 or the like.

The position information sensor 111 obtains position information (e.g., latitude and longitude) of the vehicle 10 at a predetermined time period. The position information sensor 111 is, for example, a GPS (Global Positioning System) receiver unit, a wireless LAN communication unit, or the like.

The environmental information sensor 112 is a means or unit that serves to sense the surroundings of the vehicle 10. The environmental information sensor 112 may be, for example, a camera that captures an image by using an imaging element such as a CCD (Charge Coupled Device) image sensor, a CMOS (Complementary Metal Oxide Semiconductor) image sensor or the like. The environmental information sensor 112 may be a laser scanner, a LIDAR, or a radar.

The vehicle speed sensor 113 is a sensor that detects the speed of the vehicle 10. The acceleration sensor 114 is a sensor that detects the acceleration and deceleration of the vehicle 10. The detection value of the acceleration sensor 114 becomes a positive value in the case where the speed increases, and becomes a negative value in the case where the speed decreases. Here, note that the acceleration sensor 114 may be omitted by differentiating the detection value of the vehicle speed sensor 113 to detect the acceleration of the vehicle 10. In addition, the jerk of the vehicle 10 can also be calculated by differentiating the detection value of the acceleration sensor 114.

The steering angle sensor 115 is a sensor that detects a steering angle obtained by a steering operation of the driver. The steering angle sensor 115 detects, for example, an angle of a steering wheel. Here, note that the angle of the steering wheel is detected as the steering angle in the present embodiment, but a value directly or indirectly representing a turning angle of a tire may be used. The lateral acceleration sensor 116 is a sensor that detects a lateral acceleration of the vehicle 10. The accelerator sensor 117 is a sensor that detects an amount of depression of an accelerator pedal by the driver. The brake sensor 118 is a sensor that detects an amount of depression of a brake pedal by the driver.

The device group 120 is a plurality of devices that are included in the vehicle 10 and controlled by the controller 100. The device group 120 includes, for example, a steering device 121, a drive device 122, and a brake device 123. The device group 120 may further include a shift device or the like. Although an electric vehicle is described as an example in this embodiment, a target vehicle may be a vehicle with an engine.

The steering device 121 is a steering system included in the vehicle 10. The steering device 121 is composed of including an interface (such as a steering wheel or the like), a steering motor 1211, a gear box, a steering column, and the like. The steering motor 1211 is a means or device for assisting a steering operation. When the steering motor 1211 is driven in response to a command from the controller 100, a force required for steering operation can be reduced. In addition, by driving the steering motor 1211, it is possible to automate the steering operation without depending on the operation of the driver.

The drive device 122 is a drive system included in the vehicle 10. The drive device 122 is composed of including a drive motor 1221, a drive shaft, a transmission, and the like. The drive motor 1221 is a means or device for driving the vehicle 10. The drive motor 1221, which has received a command from the controller 100, drives the vehicle 10, so that the vehicle 10 can be caused to travel.

The brake device 123 is a mechanical brake system included in the vehicle 10. The brake device 123 is composed of including an interface (such as a brake pedal or the like), an actuator 1231, a hydraulic system, a brake cylinder, and the like. The actuator 1231 is a means or device for controlling hydraulic pressure in the brake system. The actuator 1231, which has received a command from the controller 100, controls the brake hydraulic pressure, so that the braking force by the mechanical brake can be ensured.

### (Functional Configuration)

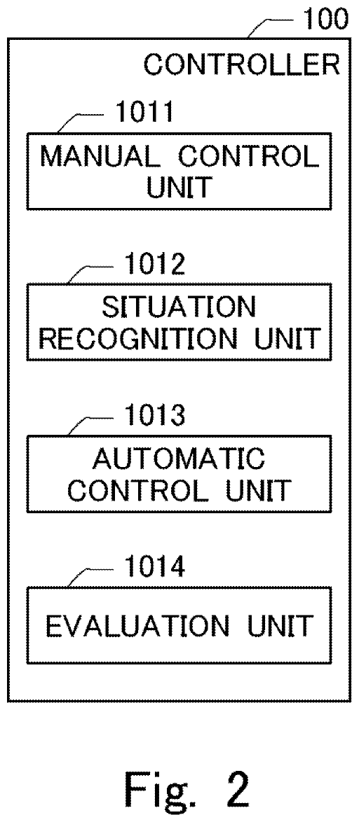

FIG. 2 is a diagram illustrating an example of a functional configuration of the controller 100 of the vehicle 10 according to the present embodiment. The controller 100 includes, as its functional components, a manual controller 1011, a situation recognition unit 1012, an automatic controller 1013, and an evaluation unit 1014. The manual controller 1011, the situation recognition unit 1012, the automatic controller 1013, and the evaluation unit 1014 are functional components that are provided, for example, by the processor 101 of the controller 100 executing various programs stored in the auxiliary storage unit 103.

The manual controller 1011 controls the vehicle during manual driving by the driver. The manual controller 1011 generates a control command for controlling the device group 120 based on a detection value of the steering angle sensor 115, a detection value of the accelerator sensor 117, a detection value of the brake sensor 118, and the like.

The manual controller 1011 can control the steering angle or the angle of the steering wheel by controlling the steering motor 1211 included in the steering device 121. The manual controller 1011 controls the turning angle of the wheels of the vehicle 10, for example, by driving the steering motor 1211 according to the detection value of the steering angle sensor 115. A known technique can be used for this control.

In addition, the manual controller 1011 controls the rotational speed of the drive motor 1221 by controlling the drive voltage, current, drive frequency, or the like. The manual controller 1011 controls the rotational speed of the drive motor 1221, for example, in accordance with the detection value of the accelerator sensor 117. A known technique can be used for this control.

Moreover, the manual controller 1011 controls the braking force of the mechanical brake by controlling the actuator 1231 included in the brake device 123. The manual controller 1011 controls the brake hydraulic pressure by driving the actuator 1231 according to the detection value of the brake sensor 118. A known technique can be used for this control.

The situation recognition unit 1012 detects the environment around the vehicle 10 based on the data obtained by the sensors included in the sensor group 110. Examples of objects to be detected include, but are not limited to, the number and positions of lanes, the number and positions of other vehicles present around the own vehicle, the number and positions of obstacles (e.g., pedestrians, bicycles, structures, buildings, and the like) present around the own vehicle, the structure of a road, and road signs. Any object may be detected as long as it is necessary to perform autonomous traveling. The data related to the environment (hereinafter, also referred to as environmental data) detected by the situation recognition unit 1012 is stored in the auxiliary storage unit 103.

The automatic controller 1013 controls the vehicle 10 during automatic driving of the vehicle 10. The automatic controller 1013 generates a control command for controlling the device group 120 by using the environmental data detected by the situation recognition unit 1012. The automatic controller 1013 controls the acceleration and deceleration, the steering angle, the rate of change of the steering angle, the lateral acceleration, the lateral jerk, or the like by controlling the device group 120.

The automatic controller 1013 generates, for example, a travel trajectory of the vehicle 10 based on the environmental data, determines the acceleration and deceleration, the steering angle, the rate of change of the steering angle, the lateral acceleration, or the lateral jerk, and controls the device group 120, so as to cause the vehicle to travel along the travel trajectory. Here, note that as a method of causing the vehicle to travel in an autonomous manner, there can be adopted a known method. During autonomous traveling, feedback control based on the detection values of the sensor group 110 may be performed.

The evaluation unit 1014 evaluates the driving operation of the driver. Here, in the vehicle 10 according to the present embodiment, automatic driving by the controller 100 and manual driving by the driver can be switched over from one to the other. For example, the driver selects either manual driving or automatic driving through the input unit 104. Even during manual driving, the automatic controller 1013 determines, based on the environmental data, the acceleration and deceleration, the steering angle, the rate of change of the steering angle, the lateral acceleration, or the lateral jerk. The data indicating the acceleration and deceleration, the steering angle, the rate of change of the steering angle, the lateral acceleration, or the lateral jerk, each of which is determined based on the environmental data during manual driving, is hereinafter also referred to as “reference data”. In addition, the data indicating the acceleration and deceleration, the steering angle, the rate of change of the steering angle, the lateral acceleration, or the lateral jerk, each of which is detected by the sensor group 110 during manual driving, is hereinafter also referred to as “detection data”. The evaluation unit 1014 evaluates the driving operation of the driver by comparing the detection data with the reference data during manual driving.

Hereinafter, the acceleration and deceleration, the steering angle, the rate of change of the steering angle, the lateral acceleration, or the lateral jerk is also referred to as a “state quantity”. The reference data is, for example, data indicating a state quantity in the case where the driver has performed an ideal driving operation, or data indicating a state quantity in the case where the driver has performed an appropriate driving operation. The evaluation by the evaluation unit 1014 is performed, for example, by determining whether a degree of deviation between the detection data and the reference data is equal to or greater than a threshold value. The degree of deviation may be, for example, a difference or a ratio. For example, when the difference or ratio between the detection data and the reference data is equal to or greater than the threshold value, it is determined that the driving operation of the driver is inappropriate, and a warning or notification is given to the driver or an external organization. The external organization is, for example, the police. The notification to the external organization may be performed via a server. The warning or notification to the driver is performed, for example, via the output unit 105. The threshold value for the difference or ratio between the detection data and the reference data has been determined in advance as an upper limit value of the difference or ratio between the detection data and the reference data in the case where the driver performs an appropriate driving operation, and has been stored in the auxiliary storage unit 103. Here, note that the threshold value may vary based on the environmental data.

The reference data is a state quantity determined by the automatic controller 1013. That is, the driving operation of the driver during manual driving is evaluated with reference to the state quantity at the time of assuming that automatic driving is being performed. Therefore, even during manual driving, the automatic controller 1013 generates the travel trajectory of the vehicle 10 based on the environmental data, and determines the state quantity so that the vehicle 1 travels along the travel trajectory.

For example, in cases where the difference between the acceleration and deceleration (positive value) and the reference data is equal to or greater than the threshold value, it can be determined that the driver is performing inappropriate rapid acceleration. In addition, for example, in cases where the absolute value of the difference between the acceleration and deceleration (negative value) and the reference data is equal to or greater than the threshold value, it can be determined that the driver has applied inappropriate sudden braking. Further, for example, in cases where the difference between the rate of change of the steering angle and the reference data is equal to or greater than the threshold value, it can be determined that the driver has performed inappropriate rapid steering.

When such an inappropriate driving operation as described above is performed, vehicles around the own vehicle may be troubled. Therefore, in cases where it is determined that the difference or ratio between the detection data and the reference data is equal to or greater than the threshold value, for example, a warning to the driver is displayed on the output unit 105, or a warning sound is generated from the output unit 105. Here, note that the evaluation unit 1014 may transmit information about the driver, who performs an inappropriate driving operation, to the server via the communication unit 106. Then, for example, the server may notify the police of the inappropriate driving operation. In addition, the evaluation unit 1014 may directly transmit information about the driver, who is driving improperly, to an external organization (e.g., the police) via the communication unit 106.

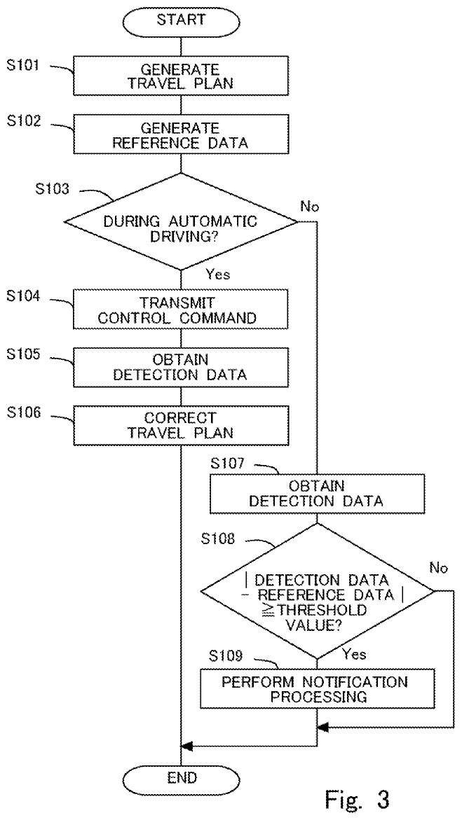

Next, the processing of evaluating the driving operation of the driver according to the present embodiment will be described. FIG. 3 is a flowchart of the processing of evaluating the driving operation of the driver according to the present embodiment. The processing or routine illustrated in FIG. 3 is executed by the controller 100 at each predetermined time period. Here, note that the following description will be made on the premise that the environmental data has already been obtained.

First, in step S101, the automatic controller 1013 generates a travel plan based on the environmental data. The travel plan is data indicating the behavior of the vehicle 10 in the predetermined time period. The travel plan may include a travel trajectory of the vehicle 10 or may include information on the acceleration and deceleration of the vehicle 10.

Then, in step S102, the automatic controller 1013 generates reference data for achieving the travel plan. For example, the reference data for the acceleration and deceleration and the reference data for the rate of change of the steering angle are generated based on parameters set in advance, such as a relation between the vehicle speed and the maximum steering angle, a relation between the traveling environment and the acceleration and deceleration or the rate of change of the steering angle, and a time width in which an operation (e.g., lane change) is to be completed.

In step S103, the automatic controller 1013 determines whether the vehicle 10 is in automatic driving. This routine is executed during both the automatic driving and the manual driving, but the processing after step S103 is different between the automatic driving and the manual driving. In cases where an affirmative determination is made in step S103, the processing goes to step S104, whereas in cases where a negative determination is made, the processing goes to step S107.

Subsequently, in step S104, the automatic controller 1013 transmits a control command generated based on the reference data to the device group 120. In step S105, the automatic controller 1013 obtains the detection data after transmitting the control command.

Thereafter, in step S106, the automatic controller 1013 corrects the travel plan based on the detection data. In this step, it is determined based on the data obtained by the sensor group 110 whether the vehicle 10 is in a desired state. Since the behavior of the vehicle 10 is affected by the current load of the drive motor 1221, the situation of the road (e.g., gradient) and the like, it is determined based on the reception of feedback of sensor data whether a desired physical control quantity has been obtained. For example, in cases where the feedback data indicates that the load of the drive motor 1221 is high and a requested acceleration cannot be obtained, the travel plan is corrected so as to obtain a higher acceleration.

On the other hand, in step S107, the evaluation unit 1014 obtains detection data. This detection data is data indicating a state quantity related to the driving operation of the driver.

Then, in step S108, the evaluation unit 1014 determines whether an absolute value of a value obtained by subtracting the reference data from the detection data is equal to or greater than the threshold value. In this step, the evaluation unit 1014 determines whether the driving operation of the driver is inappropriate. When the absolute value of the value obtained by subtracting the reference data from the detection data is equal to or greater than the threshold value, it is determined that the driving operation is inappropriate, whereas when the absolute value is less than the threshold value, it is determined that the driving operation is appropriate. In cases where an affirmative determination is made in step S108, the processing goes to step S109, whereas in cases where a negative determination is made, this routine is ended.

In step S109, the evaluation unit 1014 executes notification processing. The notification processing is, for example, the processing of notifying the driver, the external organization, or the server that the driving operation of the driver is inappropriate. The notification processing is an example of predetermined processing. The evaluation unit 1014 notifies the driver, for example, by issuing a voice from the output unit 105, displaying a text for warning, or flashing a lamp. In addition, for example, the evaluation unit 1014 transmits information indicating that the driving operation of the driver is inappropriate to the server via the communication unit 106. The server, which has received this information, notifies the police to that effect, for example.

Moreover, the evaluation unit 1014 transmits information indicating that the driving operation of the driver is inappropriate, for example, to an external organization (e.g., the police).

Here, note that in order to suppress an erroneous notification, the above notification may be performed only in cases where a state in which the absolute value of the value obtained by subtracting the reference data from the detection data is equal to or greater than the threshold value continues for a predetermined length of time or more. The predetermined length of time has been determined in advance as a length of time for which it is possible to determine whether the operation of the driver is appropriate.

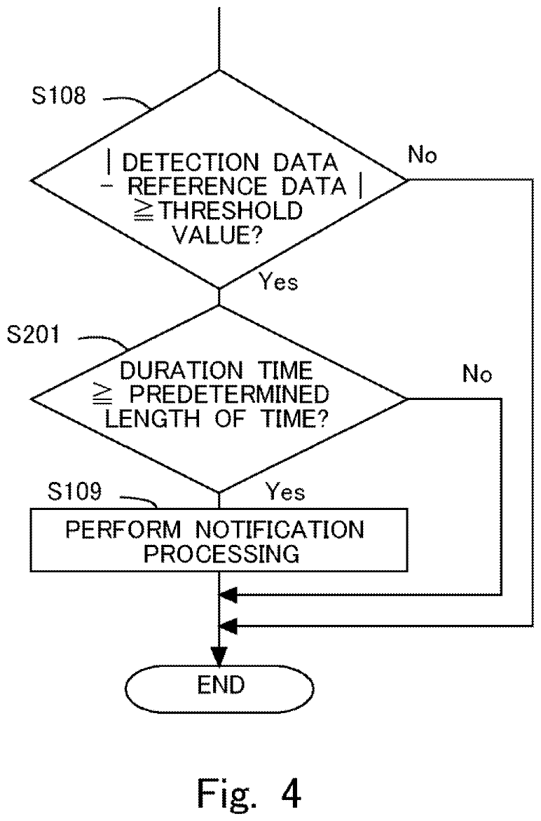

FIG. 4 is a flowchart of the processing in the case where the notification processing is performed only in cases where the state in which the absolute value of the value obtained by subtracting the reference data from the detection data is equal to or greater than the threshold value continues for a predetermined length of time or more. The processing illustrated in FIG. 4 is executed by the controller 100 at each predetermined time period. The processing before step S108 is the same as that in the flowchart illustrated in FIG. 3, and thus the illustration and description thereof will be omitted. In the flowchart illustrated in FIG. 4, in cases where an affirmative determination is made in step S108, the processing goes to step S201. In step S201, it is determined whether the duration of the state in which the absolute value of the value obtained by subtracting the reference data from the detection data is equal to or greater than the threshold value is equal to or greater than the predetermined length of time. In cases where an affirmative determination is made in step S201, the processing goes to step S109, where notification processing is performed, whereas in cases where a negative determination is made, this routine is ended. In this way, by performing the notification processing in the case where the duration of the inappropriate driving operation is equal to or longer than the predetermined length of time, an erroneous notification can be suppressed.

Here, note that in the present embodiment, the driving operation of the driver may be evaluated in cases where manual driving is being performed despite the state in which automatic driving is possible. For example, in cases where the driver drives in an agitated manner, he or she needs to switch from automatic driving to manual driving. In such a case, an inappropriate driving operation is performed. Therefore, the processing illustrated in FIG. 3 or FIG. 4 may be executed by using as a trigger the switching from automatic driving to manual driving.

As described above, according to the present embodiment, the driving operation of the driver can be evaluated on the basis of the driving operation during automatic driving. Thus, it is possible to detect and notify that the driver has performed an inappropriate driving operation during manual driving. Accordingly, it is possible to prevent the driver from performing the inappropriate driving operation.

### Second Embodiment

In a second embodiment, reference data is generated in consideration of the behavior of vehicles other than the own vehicle. For example, when passing through a place under road construction, the vehicle 10 may have to travel on an opposite lane. In such a case, when looking at the behavior of the own vehicle alone, it may be determined that an inappropriate driving operation is being performed. Therefore, in the present second embodiment, even in a state where it can be determined that the driving operation is inappropriate in the first embodiment, if, however, the behavior of the own vehicle shows the same tendency as the behavior of the other vehicles, it is determined that the driving operation is appropriate.

Therefore, in the present second embodiment, there is provided a server that obtains detection data of other vehicles. Then, the server provides the own vehicle with the detection data of the other vehicles. In the present second embodiment, the server obtains the detection data of the other vehicles, but instead of this, the own vehicle may directly obtain the detection data from the other vehicles through inter-vehicle communication. In addition, what is provided from the server to the own vehicle may be real-time detection data including immediately before or immediately after the current time point, or may be detection data accumulated in the past. Further, it may be an average value of past detection data.

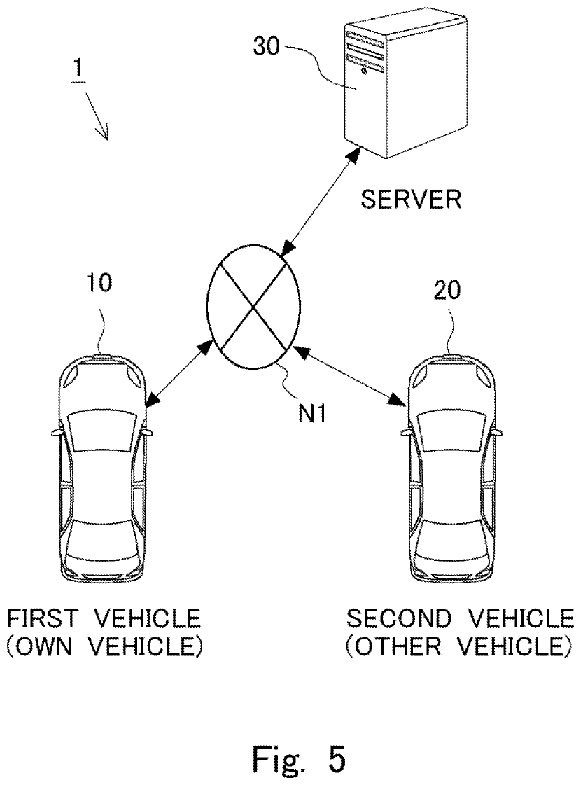

FIG. 5 is a view illustrating a schematic configuration of a system 1 according to the present second embodiment. The system 1 illustrated in FIG. 5 includes a first vehicle 10A, a second vehicle 10B, and a server 30. The first vehicle 10A is an example of the own vehicle. The second vehicle 10B is an example of other vehicles.

The first vehicle 10A, the second vehicle 10B, and the server 30 are connected to one another by a network N1. Here, note that the network N1 is, for example, a global public communication network such as the Internet, but a wide area network (WAN) or other communication networks may be employed. In addition, the network N1 may include a telephone communication network such as a mobile phone network, and a wireless communication network such as Wi-Fi (registered trademark). FIG. 5 illustrates the single first vehicle 10A and the single second vehicle 10B by way of example, but there may be a plurality of first vehicles 10A and a plurality of second vehicles 10B. In the present second embodiment, the first vehicle 10A and the second vehicle 10B will be described separately for the sake of convenience, but each vehicle 10 also has the function of any of the first vehicle 10A and the second vehicle 10B. In the following, in cases where the first vehicle 10A and the second vehicle 10B are not distinguished from each other, they are referred to simply as vehicles 10.

### (Hardware Configuration)

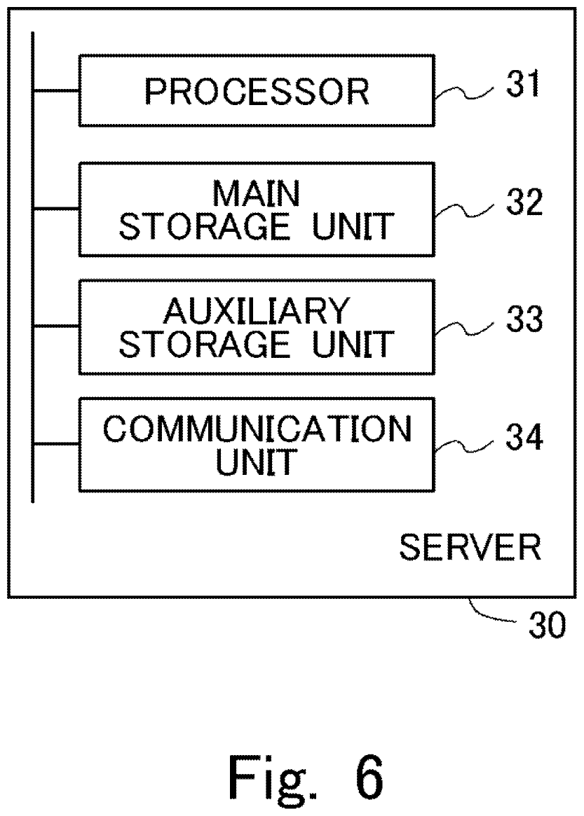

Next, the hardware configuration of the server will be described based on FIG. 6. FIG. 6 is a block diagram schematically illustrating an example of a configuration of the server 30 that constitutes the system 1 according to the present second embodiment. Note that the hardware configurations of the first vehicle 10A and the second vehicle 10B are each the same as the configuration of the vehicle 10 illustrated in FIG. 1, and hence, the description thereof will be omitted.

The server 30 includes a processor 31, a main storage unit 32, an auxiliary storage unit 33, and a communication unit 34. These components are connected to one another by a bus. The processor 31, the main storage unit 32, the auxiliary storage unit 33, and the communication unit 34 of the server 30 are the same as the processor 101, the main storage unit 102, the auxiliary storage unit 103, and the communication unit 106 of the vehicle 10 described in the first embodiment, and hence, the description thereof will be omitted.

### (Functional Configuration: Vehicle)

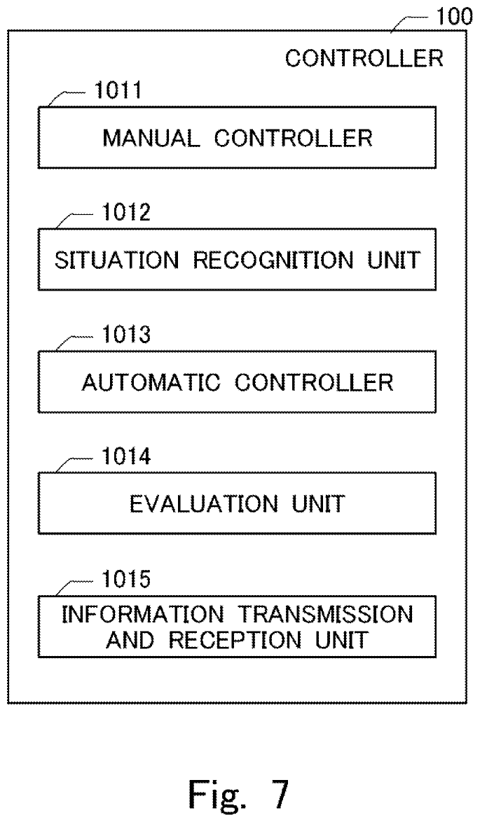

FIG. 7 is a diagram illustrating an example of a functional configuration of a controller 100 of a vehicle 10 according to the present second embodiment. The controller 100 includes, as its functional components, a manual controller 1011, a situation recognition unit 1012, an automatic controller 1013, an evaluation unit 1014, and an information transmission and reception unit 1015. The manual controller 1011, the situation recognition unit 1012, the automatic controller 1013, the evaluation unit 1014, and the information transmission and reception unit 1015 are functional components provided by a processor of the controller 100 executing various programs stored in the auxiliary storage unit 103, for example. Since the manual controller 1011, the situation recognition unit 1012, and the automatic controller 1013 are the same as those in the first embodiment, the description thereof will be omitted.

The information transmission and reception unit 1015 transmits detection data to the server 30 via the communication unit 106. Hereinafter, the detection data obtained by the first vehicle 10A is also referred to as own vehicle data, and the detection data obtained by the second vehicle 10B is also referred to as other vehicle data. When transmitting the own vehicle data to the server 30, the information transmission and reception unit 1015 may also transmit an evaluation result obtained by the evaluation unit 1014 along with it. In the present second embodiment, the own vehicle data is transmitted to the server 30 regardless of whether the driving operation of the driver is inappropriate, but instead of this, the own vehicle data may be transmitted to the server 30 only in cases where the driving operation of the driver is inappropriate. In this way, the amount of communication can be reduced.

The timing at which the information transmission and reception unit 1015 transmits the own vehicle data can be set as appropriate; for example, the own vehicle data may be transmitted in the notification processing, may be transmitted periodically, may be transmitted in accordance with the timing at which some information is transmitted to the server 30, or may be transmitted in response to a request from the server 30. The information transmission and reception unit 1015 transmits the own vehicle data to the server 30 in association with the identification information (vehicle ID) for identifying the vehicle 10 and the date and time when the own vehicle data was obtained.

In addition, the information transmission and reception unit 1015 receives the other vehicle data from the server 30. The other vehicle data thus received may be other vehicle data related to points at which the first vehicle 10A travels or other vehicle data related to points within a predetermined area from the current location of the first vehicle 10A. The predetermined area may be an area in which the first vehicle 10A can travel.

The evaluation unit 1014 according to the present second embodiment takes into consideration the other vehicle data when evaluating the driving operation of the driver. For example, even when the difference between the own vehicle data and the reference data is equal to or greater than the threshold value, notification processing is not performed in cases where the difference between the own vehicle data and the other vehicle data is less than a threshold value. The threshold value is a lower limit value of the difference between the own vehicle data and the other vehicle data in the case where the tendency of the driving operation is different between the first vehicle 10A and the second vehicle 10B. This threshold value may be the same as or different from the threshold value in step S108. The threshold value has been determined in advance and stored in the auxiliary storage unit 103. Note that the threshold value may vary based on environmental data. Further, in the present second embodiment, the processing based on the difference between the own vehicle data and the other vehicle data will be described as an example, but processing using a ratio instead of the difference is also possible.

In cases where the difference between the own vehicle data and the other vehicle data is less than the threshold value, it means that the driving operations of the same tendency are being performed in the first vehicle 10A and the second vehicle 10B. For example, in the case of avoiding an obstacle on a road or avoiding a place under construction, the driver of each vehicle 10 often performs the driving operation of the same tendency. Therefore, it is determined that the driving operation is appropriate in the first vehicle 10A in which the driving operation of the same tendency as that in the second vehicle 10B is performed.

### (Functional Configuration: Server)

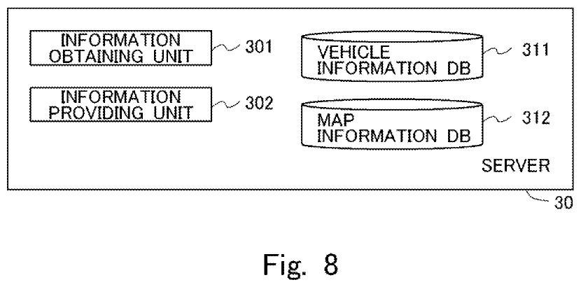

FIG. 8 is a diagram illustrating an example of a functional configuration of the server 30. The server includes, as its functional components, an information obtaining unit 301, an information providing unit 302, a vehicle information DB 311, and a map information DB 312. The information obtaining unit 301 and the information providing unit 302 are functional components provided, for example, by the processor 31 of the server 30 executing various programs stored in the auxiliary storage unit 33.

The vehicle information DB 311 and the map information DB 312 are, for example, relational databases that are created by a program of a database management system (DBMS) executed by the processor 31 managing data stored in the auxiliary storage unit 33. Here, note that any of the functional components of the server 30 or a part of the processing thereof may be executed by another computer connected to the network N1.

The information obtaining unit 301 obtains and manages information (own vehicle data, data related to evaluation results, and the like) transmitted from each vehicle 10. The information obtaining unit 301 stores the information transmitted from each vehicle in the vehicle information DB 311 in association with each vehicle ID and each date and time.

The information providing unit 302 transmits to the first vehicle 10A the other vehicle data corresponding to the current location thereof. The information providing unit 302 transmits the other vehicle data, which has been stored in the vehicle information DB 311 and which corresponds to the current location of the first vehicle 10A. The other vehicle data to be transmitted to the first vehicle 10A may be other vehicle data related to the second vehicle 10B that has performed the notification processing at the current location of the first vehicle 10A. In addition, the information providing unit 302 may transmit the other vehicle data to the first vehicle 10A when there is a request from the first vehicle 10A, or may transmit the other vehicle data to the first vehicle 10A regardless of whether there is a request from the first vehicle 10A.

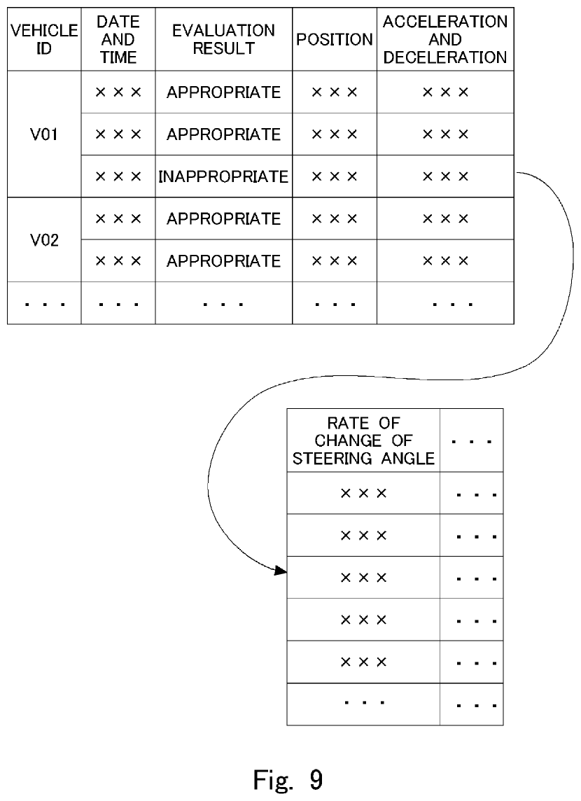

The vehicle information DB 311 is formed by storing information received from each vehicle 10 in the auxiliary storage unit 33. The vehicle information DB 311 stores information related to vehicle ID, date and time, information related to evaluation results, and own vehicle data (e.g., information related to acceleration and deceleration, information related to the rate of change of steering angle, and the like). Here, the configuration or structure of the information stored in the vehicle information DB 311 will be described based on FIG. 9. FIG. 9 is a diagram illustrating a table configuration stored in the vehicle information DB 311. The information table includes, for example, fields of vehicle ID, date and time, evaluation result, position, acceleration and deceleration, and the rate of change of steering angle. In the vehicle ID field, identification information for identifying each vehicle 10 is entered. In the date and time field, information related to the date and time when the information was obtained is entered. In the evaluation result field, information on the evaluation result of the driving operation of each driver transmitted by each vehicle 10 is entered. In the position field, the position information transmitted by each vehicle 10 is entered. In the acceleration and deceleration field, information related to the acceleration and deceleration transmitted by each vehicle 10 is entered. In the steering angle change rate field, information related to the rate of change of steering angle transmitted by each vehicle 10 is entered.

The map information DB 312 stores map information including map data, and POI (Point of Interest) information such as characters, photographs, etc., representing features of each point on the map data. The map information DB 312 may be provided from another system, e.g., a GIS (Geographic Information System), connected to the network N1. The map data includes, for example, link data related to roads (links), node data related to node points, intersection data related to each intersection, search data for searching for routes, facility data related to facilities, search data for searching for points, or the like.

### (Flow of Processing: System)

In the present second embodiment, in cases where the absolute value of the value obtained by subtracting the reference data from the detection data in the first vehicle 10A is equal to or greater than the threshold value, the evaluation unit 1014 of the first vehicle 10A requests other vehicle data from the server 30. When this request has been made, the server 30 determines, by referring to the vehicle information DB 311, whether a record exists in which position information corresponding to the current location of the first vehicle 10A has been entered and in which information indicating an inappropriate evaluation result has been entered. Then, when the record exists, the server 30 transmits the other vehicle data to the first vehicle 10A. Here, note that when such a record does not exist, the server 30 may notify the first vehicle 10A to that effect.

In the first vehicle 10A that has received the other vehicle data, the evaluation unit 1014 makes a comparison between the own vehicle data and the other vehicle data, and if a difference therebetween is less than the threshold value, notification processing is not carried out. For example, in cases where road works are being carried out on a road and it is necessary to pass through an opposite lane, the difference between the detection data and the reference data may be equal to or greater than the threshold value. However, in this case, it is not necessary to perform notification processing because the driver is simply performing a driving operation in a manner appropriate to the situation at that time. Therefore, if notification processing is not carried out when the difference between the own vehicle data and the other vehicle data is less than the threshold value, it is possible to suppress an erroneous notification.

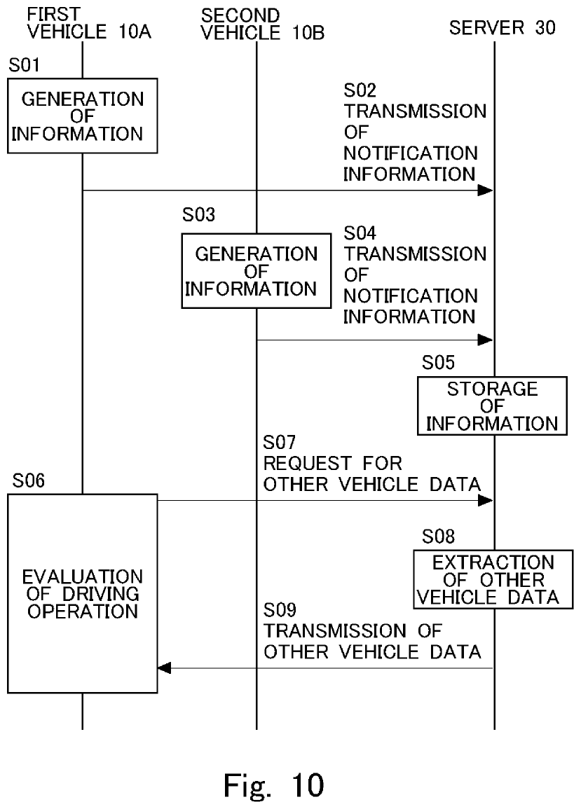

FIG. 10 is a sequence diagram of the processing of the system 1 at the time when the server 30 provides the first vehicle 10A with the other vehicle data. Note that FIG. 10 illustrates an example of a case where the number of first vehicles 10A and the number of second vehicles 10B are each one.

The vehicles 10 each generate information including their own vehicle data and data related to evaluation results (S01, S03), and transmit the information to the server 30 (S02, S04). The server having received the information from each of the vehicles 10 updates the vehicle information DB 311 and stores the information thus updated (S05). The processings from S01 to S05 are executed in a repeated manner. In the first vehicle 10A, the own vehicle data is compared with the reference data so as to evaluate the driving operation of the driver (S06). At this time, in cases where it is determined that the driving operation of the driver is inappropriate, information for requesting the other vehicle data is transmitted from the first vehicle 10A to the server 30 (S07). When receiving a request for other vehicle data, the server 30 extracts, based on the position information of the first vehicle 10A, the other vehicle data pertaining to a second vehicle 10B, for which the driving operation of its driver at the same location has been evaluated as inappropriate (S08), and transmits the other vehicle data to the first vehicle 10A (S09). Then, in the first vehicle 10A, the driving operation of the driver thereof is evaluated by making a comparison between the own vehicle data and the other vehicle data.

### (Flow of Processing: Server)

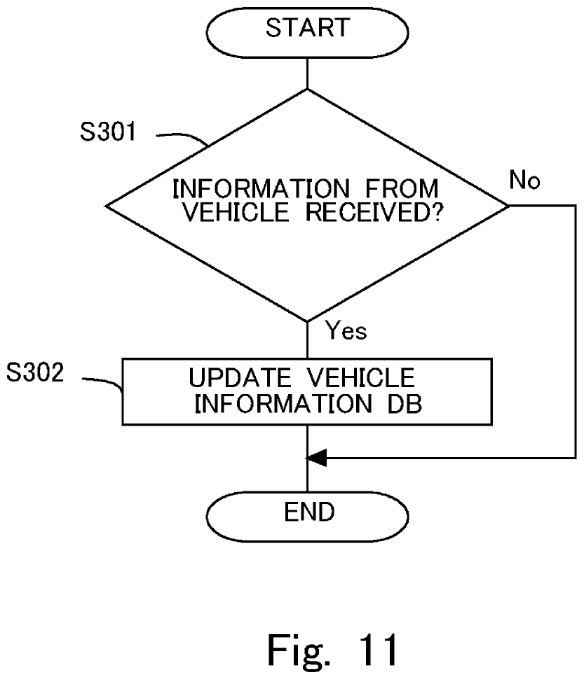

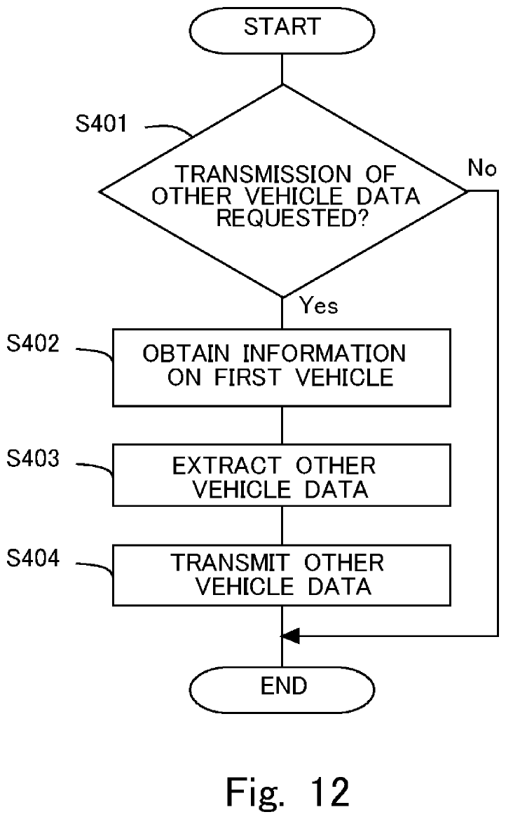

Now, the processing of the server 30 according to the second embodiment will be described with reference to FIGS. 11 and 12. FIG. 11 is a flowchart illustrating an example of the processing of the server 30 when the server 30 updates the vehicle information DB 311. The processing illustrated in FIG. is executed by the information obtaining unit 301 at predetermined time intervals (e.g., at regular periodic intervals).

In step S301, the information obtaining unit 301 determines whether the own vehicle data and the data related to the evaluation result have been received from the first vehicle 10A. In cases where an affirmative determination is made in step S301, the processing goes to step S302, whereas in cases where a negative determination is made, this routine is ended. In step S302, the information obtaining unit 301 updates the vehicle information DB 311 based on the information received from each of the vehicles 10. That is, the information transmitted from each of the vehicles 10 is stored in the vehicle information DB 311 in association with each vehicle ID and each date and time.

Next, FIG. 12 is a flowchart illustrating an example of the processing of the server 30 at the time when the server 30 transmits other vehicle data to the first vehicle 10A. The processing illustrated in FIG. is executed by the information providing unit 302 at predetermined time intervals (e.g., at regular periodic intervals). Here, note that the following description is based on the assumption that the vehicle information DB 311 has been generated before the execution of this routine.

In step S401, the information providing unit 302 determines whether a request to transmit other vehicle data has been received from the first vehicle 10A. In cases where an affirmative determination is made in step S401, the processing goes to step S402, whereas in cases where a negative determination is made, this routine is ended. In step S402, the information providing unit 302 obtains information related to the first vehicle 10A from the vehicle information DB 311. In step S403, referring to the vehicle information DB 311, the information providing unit 302 extracts, as other vehicle data, the detection data of the second vehicles 10B that have passed through the position or location corresponding to the current location of the first vehicle 10A. At this time, detection data in records in which the evaluation result is “inappropriate” may be extracted. In addition, detection data in records with a predetermined degree of similarity in time zone may also be extracted. The predetermined degree of similarity indicates, for example, that there is only a difference with no or little influence in the evaluation of the driving operation. In addition, in cases where information about the weather is stored in each record, detection data in records in which the weather is the same may be extracted. Then, in step S404, the information providing unit 302 transmits the other vehicle data to the first vehicle 10A.

### (Flow of Processing: First Vehicle)

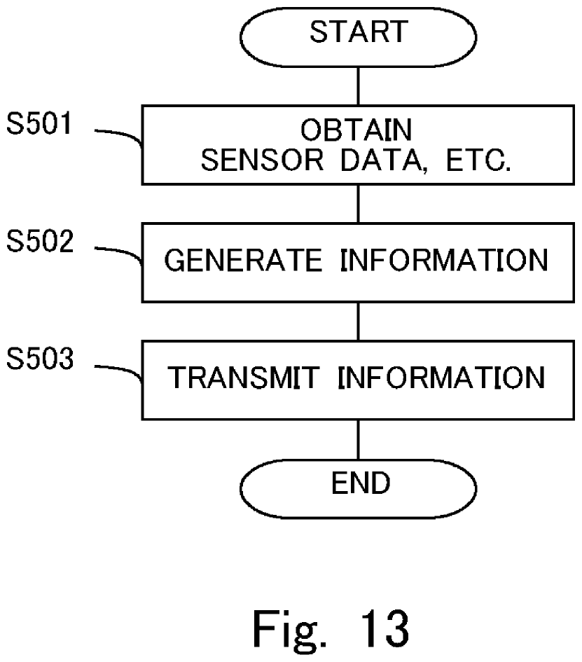

Next, by referring to FIG. 13, the processing of transmitting detection data and the like in each vehicle 10 to the server 30 will be described. FIG. 13 is a flowchart illustrating a flow of the processing of transmitting detection data and the like in each vehicle 10 to the server 30. The processing illustrated in FIG. 13 is executed by the information transmission and reception unit 1015 at predetermined time intervals (e.g., at regular periodic intervals).

In step S501, the information transmission and reception unit 1015 obtains the own vehicle data and data related to the evaluation result. In step S502, the information transmission and reception unit 1015 generates information to be transmitted to the server 30. This information includes the vehicle ID, the date and time when the own vehicle data was obtained, the own vehicle data, and data related to the evaluation result. Then, in step S503, the information transmission and reception unit 1015 transmits the information thus generated to the server 30.

### (Flow of Notification Processing: First Vehicle)

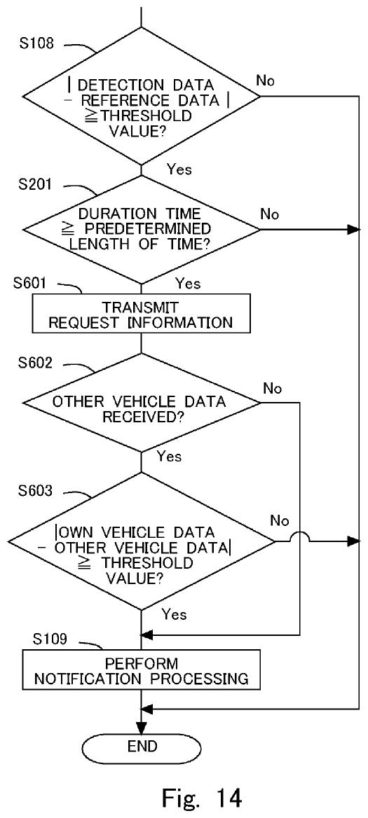

FIG. 14 is a flowchart of processing in the case of performing notification processing according to the present second embodiment. The processing before step S108 is the same as that in the flowchart illustrated in FIG. 3, and thus, the illustration and description thereof will be omitted. The processing illustrated in FIG. 14 is executed by the controller 100 at each predetermined time period. Here, note that step S201 in FIG. 14 may be omitted.

In the flow chart illustrated in FIG. 14, in cases where an affirmative determination is made in step S201, the processing goes to step S601. In step S601, the evaluation unit 1014 transmits request information to the server 30. The request information is information for requesting the transmission of other vehicle data. The request information may include position information of the first vehicle 10A. The evaluation unit 1014 generates the request information, and transmits it to the server 30. Then, in step S602, the evaluation unit 1014 determines whether the other vehicle data has been received from the server 30. In cases where an affirmative determination is made in step S602, the processing goes to step S603. On the other hand, in cases where a negative determination is made in step S602, there is no other vehicle data, so an evaluation that an inappropriate driving operation has been performed is decided. Therefore, in cases where a negative determination is made in step S602, the processing goes to step S109, where notification processing is performed.

In step S603, the evaluation unit 1014 determines whether an absolute value of a value obtained by subtracting the other vehicle data from the own vehicle data is equal to or greater than a threshold value. In this step, it is determined whether to perform the notification processing, by using the other vehicle data. In cases where an affirmative determination is made in step S603, the driving tendency is different between the own vehicle and the other vehicle, the evaluation that an inappropriate driving operation has been performed is decided. Therefore, in cases where an affirmative determination is made in step S603, the processing goes to step S109, where the notification processing is performed. On the other hand, in cases where a negative determination is made in step S603, the driving tendency is the same between the own vehicle and the other vehicle, and thus it is evaluated that the driving operation is appropriate. Therefore, in cases where a negative determination is made in step S603, this routine is ended. Here, note that the threshold value in step S603 may be the same as or different from the threshold value in step S108.

As described above, according to the present second embodiment, accuracy in the evaluation of the driving operation of the driver during manual driving can be further improved by taking into consideration the other vehicle data, when the driving operation of the driver is evaluated based on the driving operation controlled by the controller 100 during automatic driving.

Here, note that in this second embodiment, when providing the other vehicle data to the first vehicle 10A, the server 30 may provide the other vehicle data pertaining to a record where the time zone in which the other vehicle data was obtained is the same as the current time zone. For example, the tendency of the driving operation of the driver may be different between rush hours on weekdays and off-peak hours on holidays, because the traffic volume is different therebetween. By providing the other vehicle data corresponding to such a change in the traffic volume, it is possible to further improve the accuracy of the evaluation of the driving operation of the driver during manual driving. In addition, the other vehicle data to be provided may be determined in accordance with other data affecting the driving operation, such as weather or the like.

In the present second embodiment, after an affirmative determination is made in step S108, the determination is made using the other vehicle data, but instead of this, the reference data may be caused to vary by using other vehicle data. For example, in cases where a plurality of pieces of other vehicle data showing the same tendency have been obtained at the same point as the current location of the first vehicle 10A, the processing of step S108 may be executed by using, as the reference data, average data of those pieces of other vehicle data. In this case, the reference data is transmitted from the server 30 to the first vehicle 10A before the processing of step S108 is executed. In the server 30, in cases where with reference to the vehicle information DB 311, there are a plurality of vehicles 10 whose evaluation results are inappropriate at the same position and the detection data of those vehicles have a predetermined degree of similarity, an average value of the detection data thereof may be obtained, and the average value may be set as the reference data at the position.

### Third Embodiment

In a third embodiment, the driving operation is evaluated in consideration of a degree of reliability of reference data. Here, the reference data is determined based on the detection values of the sensor group 110, but the accuracy of the sensor group 110 may vary. For example, in cases where the environmental information sensor 112 is used to detect a situation around the vehicle 10 or the like, the accuracy of image recognition may be reduced during backlighting, at night, or in rainy weather. In addition, in rainy weather, the detection accuracy of a millimeter wave radar may be reduced. Therefore, a calculated value of the reference data may vary according to a change in environment. This also affects the evaluation of the driving operation. Therefore, in the present third embodiment, the threshold value is corrected based on the degree of reliability of the reference data. For example, the threshold value for the difference between the detection data and the reference data is set in such a manner that the lower the degree of reliability, the more difficult it is to determine that the driving operation is “inappropriate” in the evaluation of the driving operation. That is, the degree of deviation between the detection data and the reference data will be allowed to be larger. The degree of reliability of the reference data may be correlated with the degree of reliability of the sensor group 110. The degree of reliability of the reference data may be set in accordance with, for example, the time zone or weather. The degree of reliability may be obtained in advance by experiments, simulations, or the like. The relation between the time zone or weather and the degree of reliability may have been stored in the auxiliary storage unit 33. Note that the time zone or weather is an example of the situation around the vehicle. For example, in the same time zone or the same weather, the situation around the vehicle or the road situation is considered to be a predetermined degree of similarity.

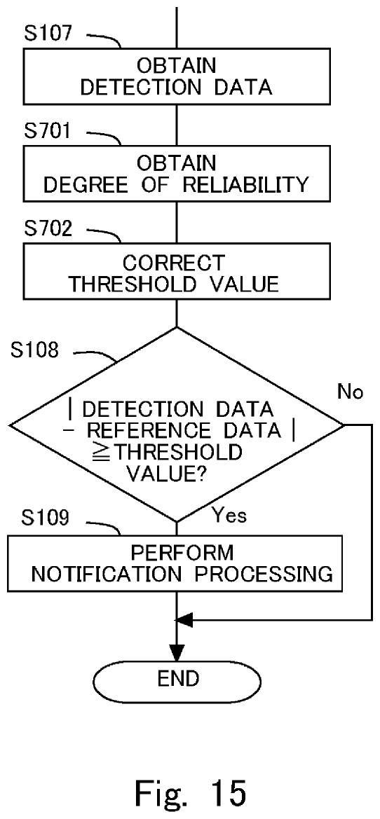

FIG. 15 is a flowchart of the processing of correcting the threshold value based on the degree of reliability of the sensor group 110. The processing before step S107 is the same as that in the flowchart illustrated in FIG. 3, and thus the illustration and description thereof will be omitted. In the flowchart illustrated in FIG. 15, when the processing of step S107 is completed, the processing or routine goes to step S701. In step S701, the degree of reliability of the sensor group 110 is obtained. The relation between the degree of reliability, and the time zone and the weather has been stored in the auxiliary storage unit 33 in advance. Therefore, the degree of reliability is obtained based on the time zone and the weather. The weather may be obtained by the environmental information sensor 112, may be obtained from the server 30, or may be obtained from another server that provides weather information. Then, in step S702, the threshold value used for the evaluation of the driving operation is corrected based on the degree of reliability. The relation between the degree of reliability and a correction amount or correction coefficient of the threshold value has been stored in the auxiliary storage unit 33 in advance. Here, note that the relation between the degree of reliability and the threshold value does not need to be linear. The threshold value may be made to change continuously or stepwise in accordance with the degree of reliability. In addition, the threshold value may be made larger as the degree of reliability is lower. Then, when the processing of step S702 is completed, the processing or routine goes to step S108.

As described above, according to the present third embodiment, when the driving operation of the driver is evaluated based on the driving operation controlled by the controller 100 during automatic driving, the threshold value is caused to vary based on the degree of reliability of the reference data, thus making it possible to further improve the accuracy of the evaluation of the driving operation of the driver during manual driving.

Here, note that in the above-described second embodiment, the degree of reliability described in the third embodiment can be used. For example, in the second embodiment, the evaluation of the driving operation using the other vehicle data may be performed only in cases where the degree of reliability of the reference data is less than a predetermined degree of reliability. In cases where the degree of reliability of the sensor group 110 is low, there is a concern that the evaluation of the driving operation may be erroneous, and hence, if the evaluation of the driving operation is performed at this time by further referring to the other vehicle data, it is possible to improve the accuracy of the evaluation of the driving operation. The predetermined degree of reliability is set as a degree of reliability with which the evaluation of the driving operation can be made in a correct manner.

### Other Embodiments

The above-described embodiments are merely some examples, and the present disclosure can be appropriately modified and implemented without departing from the gist thereof. In the above-described embodiments, the vehicle 10 includes the manual controller 1011, the situation recognition unit 1012, the automatic controller 1013, and the evaluation unit 1014, but some or all of these functional components may be included in the server 30. For example, the server 30 may evaluate the driving operation of the driver. In this case, in cases where it is determined that the driving operation is inappropriate, the server 30 may transmit information about a warning to the vehicle 10.

In addition, in the above-described embodiments, an example has been explained in which the threshold value is caused to vary, but instead of this, the same evaluation can be made even if the detection data or the reference data is made to vary.

The processing and means (devices, units, etc.) described in the present disclosure can be freely combined and implemented as long as no technical contradiction occurs.

In addition, the processing described as being performed by a single device or unit may be shared and performed by a plurality of devices or units. Alternatively, the processing described as being performed by different devices or units may be performed by a single device or unit. In a computer system, it is possible to flexibly change the hardware configuration (server configuration) that can achieve each function of the computer system.

The present disclosure can also be realized by supplying to a computer a computer program in which the functions described in the above-described embodiments are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read only memory (ROM), a random access memory (RAM), an EPROM, an EEPROM, a magnetic card, a flash memory, an optical card, or any type of medium suitable for storing electronic commands or instructions.

What is claimed is:

1. An information processing apparatus including a controller configured to execute:
obtaining a situation around a vehicle or a road situation, and generating reference data, which is data of a driving operation serving as a reference; and
performing predetermined processing when a degree of deviation between driving data, which is data of a driving operation by a driver of the vehicle, and the reference data is equal to or greater than a threshold value.

2. The information processing apparatus according to claim 1, wherein the controller generates, as the reference data, data related to acceleration and deceleration or an amount of change of steering angle.

3. The information processing apparatus according to claim 1, wherein the controller performs the predetermined processing when a time during which a degree of deviation between the driving data and the reference data is equal to or greater than the threshold value is equal to or greater than a predetermined length of time.

4. The information processing apparatus according to claim 1, wherein the controller determines whether to perform the predetermined processing based on data of the driving operation collected from an other vehicle that has passed a current location of a target vehicle on which the predetermined processing is to be performed.

5. The information processing apparatus according to claim 4, wherein the controller determines whether to perform the predetermined processing based on the data of the driving operation collected from the other vehicle, when a predetermined condition is satisfied.

6. The information processing apparatus according to claim 5, wherein the controller determines whether to perform the predetermined processing based on the data of the driving operation collected from the other vehicle when a degree of reliability of the reference data is less than a predetermined degree of reliability.

7. The information processing apparatus according to claim 4, wherein the controller determines whether to perform the predetermined processing based on data of the driving operation collected in real time from the other vehicle or data of the driving operation collected in the past from the other vehicle.

8. The information processing apparatus according to claim 7, wherein the controller uses data having a predetermined degree of similarity of the situation around the vehicle or the road situation among the data of the driving operation data collected in the past from the other vehicle.

9. The information processing apparatus according to claim 1, wherein the controller causes the threshold value to vary based on a degree of reliability of the reference data.

10. The information processing apparatus according to claim 9, wherein the controller increases the threshold value as the degree of reliability of the reference data is lower.

11. The information processing apparatus according to claim 9, wherein the controller determines the degree of reliability of the reference data based on a degree of reliability of a sensor provided in the vehicle.

12. The information processing apparatus according to claim 9, wherein the controller holds in advance a relation between the situation around the vehicle or the road situation and the degree of reliability of the reference data.

13. The information processing apparatus according to claim 1, wherein the controller performs the predetermined processing in a situation in which automatic driving of the vehicle is possible.

14. The information processing apparatus according to claim 13, wherein the controller generates automatic driving data, which is data of a driving operation during automatic driving of the vehicle, based on the situation around the vehicle or the road situation, and generates the reference data based on the automatic driving data.

15. An information processing method for causing a computer to execute:
obtaining a situation around a vehicle or a road situation, and generating reference data, which is data of a driving operation serving as a reference; and
performing predetermined processing when a degree of deviation between driving data, which is data of a driving operation by a driver of the vehicle, and the reference data is equal to or greater than a threshold value.

16. The information processing method according to claim 15, wherein data related to acceleration and deceleration or an amount of change of steering angle is generated as the reference data.

17. The information processing method according to claim 15, wherein whether to perform the predetermined processing is determined based on data of the driving operation collected from an other vehicle that has passed a current location of a target vehicle on which the predetermined processing is to be performed.

18. A non-transitory storage medium with a program stored therein for causing a computer to execute:
obtaining a situation around a vehicle or a road situation, and generating reference data, which is data of a driving operation serving as a reference; and
performing predetermined processing when a degree of deviation between driving data, which is data of a driving operation by a driver of the vehicle, and the reference data is equal to or greater than a threshold value.

19. The non-transitory storage medium with a program stored therein according to claim 18, wherein data related to acceleration and deceleration or an amount of change of steering angle is generated as the reference data.

20. The non-transitory storage medium with a program stored therein according to claim 18, wherein whether to perform the predetermined processing is determined based on data of the driving operation collected from an other vehicle that has passed a current location of a target vehicle on which the predetermined processing is to be performed.
